(19) United States
(12) Patent Application Publication
(10) Pub. No.: US 2018/0130022 A1
(43) Pub. Date: May 10, 2018

(54) MESSAGE MANAGEMENT SYSTEM AND METHOD

(71) Applicant: Ihab Ayoub, San Antonio, TX (US)

(72) Inventor: Ihab Ayoub, San Antonio, TX (US)

(21) Appl. No.: 15/805,105

(22) Filed: Nov. 6, 2017

Related U.S. Application Data
(60) Provisional application No. 62/417,584, filed on Nov. 4, 2016.

(51) Int. Cl. G06Q 10/10; H04L 12/58

(52) U.S. Cl. CPC G06Q 10/107; H04L 51/22; H04L 51/12

(57) ABSTRACT

Systems and methods for managing electronic communications are provided. At a computing device having one or more processors and memory storing programs executed by the one or more processors, an electronic communication is accessed and selected from processing according to one or more message disposition schemes. Such schemes are configured to cause deletion, archiving, updating, tagging, and source association. Expiry processing of such messages may be recipient or sender initiated, and may be based upon assigned Sender IDs or unique Message IDs. Previously received messages may be altered, deleted, or replaced by the sender or intermediary, and restrictions may be placed upon the capability to do so.

### CROSS-REFERENCE TO RELATED APPLICATIONS

This application claims priority to U.S. Provisional Patent Application No. 62/417,584, filed Nov. 4, 2016, entitled MESSAGE MANAGEMENT SYSTEM AND METHOD, and hereby incorporated by reference.

### BACKGROUND

### Field

The technology relates generally to improvements in electronic communication, storage and management, and related systems.

### Background Art

Electronic communications are increasingly a primary source of communication between parties. Due to the sheer volume of such communications particularly with unsolicited and even opt-in marketing communications, demands on networks, systems and user time and attention need to be better managed.

Accordingly, a need exists for systems and methods to better manage the increasing volumes of electronic messages and the related demands on users, systems and networks.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

A system for managing electronic messages based on expiry indicators is disclosed. Such indicators may be included by a sender, and/or parsed by an intermediate or client device from message contents. Expiry indicators may then be used to determine how the message is processed at time of receipt or at a later time, such as upon expiry.

A method for determining expiry indicators is disclosed. The method includes examining sender-provided expiry data if available, and my also examine message content, and even linked content to determine and/or validate such indicators.

A method for processing messages is disclosed. The method may include a determination of sender classifications. Different expiry schemes may then be applied based on such classifications.

To accomplish the foregoing and related ends, the following description and any annexed drawings shall set forth certain illustrative aspects and implementations. These may represent but a few of the various ways in which one or more aspects may be employed. Other aspects, advantages, and novel features of the disclosure will become apparent from the following detailed description when considered in conjunction with the annexed drawings.

### BRIEF DESCRIPTION OF DRAWINGS

The drawings are only illustrative of certain embodiments and do not limit the disclosure.

FIG. 1 depicts a block diagram of a system for transmitting electronic messages to a recipient either directly from a sender, or via a sender's intermediary.

FIG. 2 depicts a flow diagram of a method for processing messages according to an assigned disposition scheme and an expiry indicator.

### DETAILED DESCRIPTION

In one embodiment, a system and method for automatically deleting or archiving expired messages is disclosed. Expired messages are generally those communications which include a limited-time utility, such as limited time offers for the sale or purchase of goods or services, or limited participation periods for inclusion, and the like, after the passage of the relevant time period.

Whether expired messages are archived, deleted, flagged, archived pending deletion, or otherwise disposed of may be established by the recipient, an administrator, and/or the sender/source. Alternatively, a hierarchy of rules may be applied, for example, an administrator may require that expired messages be archived to local storage (freeing space on a server) and the recipient may establish how and when such messages may be deleted or archived.

Existing and incoming messages may be managed according to various expiry schemes depending on message characteristics and/or user/admin selected settings. Such expiry schemes may include, but are not limited to, deletion, archiving, categorizing, calendaring, association, and replacement.

For example, messages deemed to have been expired, either due to a lack of current utility, passage of time, redundancy, replacement with one or more relevant messages, etc. may be deleted or archived, advantageously freeing space on the storage device where such messages are kept, or transferring the burden from an active storage device to an archival or local device.

Alternatively, such messages may be categorized into various categories, each of which will have an associated expiry scheme, and then processed according to the relevant scheme. Advantages of categorizing prior to application of an expiry scheme include a greater control over quantities of messages than what may be available for individual messages. For example, if messages are categorized as marketing, one may set a quota for how many such messages will be retained on e.g., a server or user device, while applying a different quota to other categories of messages based on priorities. It may be desirable, for instance, to delete all marketing message after a certain passage of time, or a certain volume of storage is in use by such messages, or available on a storage device.

In one embodiment, incoming messages are associated with a message source and expiry schemes are based at least in part upon source-related settings, source-category (e.g., work, personal, marketing, etc.) settings, and/or the existence of one or more messages from the same source. For example, a quota may be applied for messages retained from a particular source or source category. One advantage of such configurations is a decreased storage demand for less important (e.g., by category) or expired (e.g., via expiry factors) which may be automatically purged based on the applicable expiry scheme.

In one embodiment, a method for parsing messages for identification of expiry indicators is disclosed. The method may include steps for the identification and/or verification of expiry factors and/or the automatic deletion or archiving of messages identified as having expired. Such embodiments advantageously permit proper disposition of messages even in the absence of sender/source participation. For example, the tagging of a message with expiry data by a sender is not required, and therefore such an embodiment will not rely on sender compliance.

In one embodiment, one or more expiry factors associated with the message, sender, linked content, or otherwise, are evaluated to determine which is most relevant to message expiry. Where multiple such factors are found, each may be assigned a certainty score and only the one having the highest certainty score (possibly also evaluated against a minimum certainty threshold) will be identified as the expiry factor for the associated message and the relevant expiry scheme will be applied.

In one embodiment, a system for managing email communications utilizes sender-provided or sender-associated data to alter existing messages previously sent to the recipient. For example, messages may be tagged with a Source ID (SID) and/or Message ID (MID), identifying the source and/or individual message, respectively, and then later controlled, with or without recipient involvement, after receipt. Such an embodiment advantageously permits senders to ensure that only current, relevant, or updated messages are retained in a recipient's possession, and that expired, erroneous, or outdated messages will not be relied upon. Such a system also advantageously increases the likelihood that a recipient will opt into receiving communications from a sender when it is known by the user that the overall volume of sender-initiated messages existing on a recipient server or user device will be controlled, without requiring further action on the part of the recipient.

Additionally, the use of SIDS will permit user or administrator mandated control over message volume and storage requirements. For example, the number of messages, frequency thereof, or storage space required therefor, could be limited by the recipient, without requiring interaction with a particular sender. Additionally, expiry schemes could be activated to delete, for example, the oldest message once a second, third, or other number of messages associated with a particular sender, has been received and retained. Thus, only a preset number of messages from a sender would be maintained at any given time, streamlining storage, network and user time requirements.

SID-based message management permits granular message management. Associating MIDs as well further permits post-receipt control where permitted by a recipient. For example, a seller may wish to only maintain messages on recipient devices which pertain to current and future sales, while purging prior marketing messages that are no longer relevant. Further, such a seller may wish, and a recipient would likely prefer, to maintain messages pertaining to completed purchases, or personalized communications, whilst only purging expired marketing or non-specific messages. Use of MIDs, alone or in combination with SIDs, permits such granular control.

MIDs may be structured with a standardized format, to include for example, prefixes identifying the type of message (e.g., informational, marketing, transactional, etc.), thus permitting the targeting of expiry schemes to groups of MIDs relating to particular types of messages only. Alternatively, MIDs could simply be unique identifiers and associated messages could be targeted via the individual MIDs, or a an MID range.

Use of SIDs or other sender-specific identifiers can also advantageously limit access to existing message (previously received by a recipient and accessible on a recipient device or server) to only those messages initiated by the particular sender/source. Encryption and authentication factors may also be combined with such identifiers to more securely limit access, and recipient-side controls may also take priority.

Embodiments may be disposed on recipient devices and/or servers that manage messages for a recipient or group of recipients. Similarly, group controls may be established utilizing the various identifiers and expiry schemes described herein, to control message management for groups of recipients.

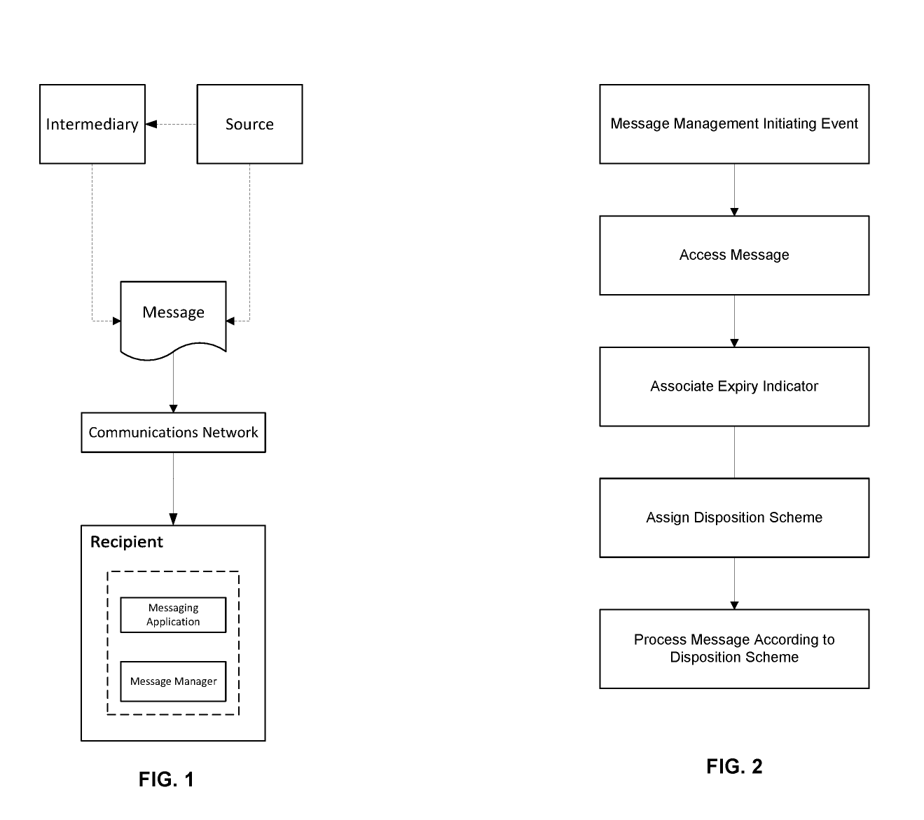

The term “sender” as used herein generally describes a particular message source. Because sender-related information such as name, address and other information may change for communications originating from the same source, it should be noted that sender-related information is one, but not the only, determinant of a message source. Message contents, including links, names, products and services may also be used to determine that a message is from (or associated with) a particular sender. One or more intermediaries may be utilized by a sender for the creation, modification and/or transmission of a message. Such intermediaries may include, but are not limited to, mail management and marketing intermediaries who provide, modify and/or transmit communications on behalf of an originating sender. FIG. 1 depicts the transmission of a message from a sender to a recipient over a communication network, either directly or via an intermediary.

In one embodiment, senders or sources may be classified and different expiry procedures may be applied based on such classification. For example, work-related communications which may contain project deadline data may be excluded from processing (or processed differently) while marketing-related communications may be processed according to expiry indicators. Expiry indicators may similarly be applied differentially to marketing vs. work communications. Classification may be based on inclusion in contact lists, sources of the messages, contents, etc. and/or may be selected by a recipient or administrator.

Embodiments of a system and method for identifying messages for expiry may include sender-side (or intermediary) tagging of messages with expiration data, such that when processed by a recipient device (or server managing messages on behalf thereof), the messages will be set to be automatically deleted or archived after the expiry date. Such tagging may be done solely for the purpose of providing expiry data separate from message contents.

Embodiments may include recipient-side processing of date information associated with the message and relating to the expiration of contents of the message. Upon identifying expired messages, such messages may be archived or deleted automatically, or flagged for archiving or deletion upon confirmation by a user or administrator.

In one embodiment, a system and method for archiving or deleting received messages is disclosed. The embodiment parses for date or time-period information in received message content, may assign a degree of certainty to an expiry determination, and flags identified messages for confirmation or alternatively for auto-deletion/archiving.

One embodiment parses for date or time-period information in received message content, and if a threshold of certainty is not met with respect to parsed information, may follow one or more links in the message to evaluate linked information regarding expiry status. Such linked information may then be appended to the internally-parsed information in making an expiry determination.

In one embodiment, expiry factors will be assigned certainty scores for determining message expiry. For example language such as “offer expires” or “good through” or “valid until” followed by a date may be assigned a higher certainty score than a date alone, when parsing message content. Additionally, expiration data provided by the sender may be assigned a higher certainty score than parsed information. Multiple expiry factors may be identified and considered, and one or more assigned as the expiry indicator based upon a certainty score (possibly only if such score meets a certainty threshold). Expiry indicators generally describes data associated with a message that is indicative of message expiry.

In one embodiment, parsing of message content for expiry information may reveal multiple dates, or a date range. Parsing of the content will proceed to determine whether a range relates to a message validity period. If so determined, the message may be automatically flagged with a reminder corresponding to the beginning of the period, and for deletion at the end of the period. Alternatively, such date ranges may be added to a recipient's calendar. Multiple dates may be similarly calendared, and the message flagged for deletion at the end of the last date range.

Parsing that indicates one or more dates have already passed may indicate that historical events are referenced, and therefore such dates would be excluded from expiry processing. Additionally, future dates within the same message may be considered for expiry processing.

In one embodiment, certain categories or sources of messages may be automatically flagged for expiration, either in the absence of a reliable expiry determination, or alternatively to override default expiry processing settings.

In one embodiment, one or more follow-up messages by a sender may be refused until the sender has provided expiry data for prior messages. Prior message expiry data may be processed by a properly configured recipient device prior to accepting further messages from that sender. In such a manner, senders will be responsible for clearing old messages from recipient mailboxes prior to sending new messages. The expiry data provided by the sender for previously-sent messages may be automatically processed by the recipient device and appropriate disposition of old messages may be indicated to the sender thus clearing the sender to provide future messages.

Configurations that require or permit sender-initiated message expiry prior to new message processing may advantageously provide both an impetus to the sender to properly manage message expiration, as well as, in certain embodiments, the ability to provide updated, relevant and/or more timely information to a recipient while mitigating the risk that the recipient will continue to rely upon previously-sent and possibly invalidated or outdated message content. For example, if relevant information regarding a topic, product or service has changed, the sender is capable of replacing the prior message with an updated message and also ensuring that the prior message is no longer relied upon by a recipient. In one embodiment, the prior message will not be deleted, but will be flagged with a notice that it has been replaced by an updated message, and may require user input for deletion. Such embodiments advantageously also increase the likelihood that a sender will provide content regarding topics that may become outdated or irrelevant, which would create liability for the sender should recipients continue to rely upon the previously-provided and now outdated information.

To ensure proper compliance with sender restrictions, in one embodiment, the system may identify message sources based on message contents, instead of solely relying upon sender information such as email addresses, etc. which may be altered. Thus, the term “sender” may in certain embodiments refer to a particular message source regardless of associated email address, and may be determined based upon a particular source of goods and services, or other factors. This is particularly beneficial when third-party marketing services or other intermediaries are used by a sender, and thus origination data of a message may not be indicative of the relevant entity associated with the message.

In one embodiment, user interaction with message content may also be factored into expiry determinations. For example, if it is determined that a recipient has followed links, responded to, purchased from, or otherwise interacted with a message, expiry may be processed differently. In one embodiment, if a second message from the same sender is received prior to the expiry period of a prior message, and the second message indicates that the recipient of the first message has made a related purchased or subscription, the expiry period of the first message may be altered, possibly to retain as relevant to the transaction, or for accelerated expiry as no longer needed.

In one embodiment, unread messages marked as time-limited, marketing-related, or similar, may be assigned a different expiry scheme, and more aggressively purged. FIG. 2 depicts a simplified process beginning with an initiating event such as a user/admin input, message receipt, sender-activation, or otherwise, followed by accessing a message, associating an expiry indicator with the message, assigning an expiry scheme based at least in part on the associated expiry indicator, and processing the message according to the expiry scheme. All of these steps may occur on a single computer system, or alternatively, certain steps may occur on separate computer systems. The variations in expiry indicators, disposition schemes and other variables are individually addressed herein.

In one embodiment, an expiry system will be standardized across unaffiliated users of the system to ensure that expiry indicators are provided and processed consistently. Such an embodiment may include uniform rules for the tagging of messages with expiry data, standardized assignment and/or configuration of SIDs and/or MIDs, standardized processing of such data by recipient and intermediary devices, and rules for processing non-compliant messages, such as refusal of future messages from non-compliant senders.

Systems and methods described herein may be incorporated into existing messaging applications to improve the functioning of the devices and networks utilized by such applications, and may also be used as separate applications that interact with existing messaging applications to process messages and message expiry as disclosed herein.

Advantages of various embodiments of the systems and methods described herein include: (1) improvements to computer devices' speed and resource utilization, requiring decreased memory and processing, (2) improvements to network speeds and utilization, requiring decreased bandwidth, (3) decreased time required from users and admins to optimize message storing resources, (4) timely optimizing of related system resources vs. manually- or periodically-initiated optimizations, (5) increased consumer participation in marketing campaigns (e.g., increased opt-ins) because accumulation of expired emails will be reduced (6) decreased storage requirements, due to more streamlined message retention, and (7) improved message search capabilities due to the decreased volume of messages retained, and decreased volume of non-relevant search results.

Various embodiments of the systems and methods described herein may be implemented by various computing devices, one or more of which may include computer readable instructions disposed in a non-transitory computer readable medium. Such devices will be improved thereby in terms of memory and other resource utilization and will generally benefit from a more efficient use of network resources due to the streamlining of data that must be accessed, processed, transmitted and/or stored.

Tagging of messages with expiry data generally refers to the inclusion of separate data with a message, that is relevant to the expiry of the message, while not necessarily incorporated into the message contents, visible to a viewer, and/or parsable during parsing of message contents. Such tagging may occur within a message header, or in any other manner that permits association and conveyance of relevant data with a particular message.

In one embodiment, expiry procedures may be accessed and/or initiated only by user- or admin-selected senders, either individually or by category. Heuristic methodologies may be implemented to assess compliance and appropriate expiry selection and application on an ongoing basis, and such processes may be modified and/or managed based on such determinations.

Quotas may be established on a message quantity, storage volume, frequency, or other basis, and may be assigned on the basis of SIDs, sender categories, whitelists or similar databases, presence or absence on contact lists, prior interactions, or otherwise. Such quotas may be utilized to restrict receipt of additional messages, and/or purge existing messages. For example, for any given SID, a quota of three messages may be established, requiring purging of an existing message once the quota is reached, prior to acceptance of a new message. In such cases, selection of messages for purging may be implemented by the sender/source or user/admin. Alternatively, purging may be automated such that once the quota is reached and a new messages is received, the oldest message assigned to that SID, category, or other criteria, will be automatically purged.

While many of the features of embodiments described herein will be beneficial to email communications, other forms of communication, include text/SMS and other electronic communications will also benefit from various implementations. In particular, significant benefits may be realized with mobile and other devices with limited storage and/or costs associated with bandwidth usage. Various embodiments will improve the operation of such devices by lessening system resource usage in processing, storing, and/or transmitting messages. In particular, quota-based controls according to sender/source and/or category may be of particular benefit to those devices having limited bandwidth or storage constraints.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Example computing devices include, but are not limited to, personal computers, server computers, hand-held or laptop devices, mobile devices (such as mobile phones, multimedia tablets, media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

The terms “comprising,” “including,” and “having,” as used in the claims and specification herein, indicate an open group that includes other elements or features not specified. The terms “a,” “an” and the singular forms of words include the plural form of the same words, and the terms mean that one or more of something is provided. The terms “at least one” and “one or more” are used interchangeably.

The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of an embodiment.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A computer-implemented method for automatically managing email based upon expiry indicators, comprising:
at a computer system having at least one processor, performing the operations of:
accessing an email message to determine expiry indicators;
associating at least one expiry indicator with the email message;
assigning a message disposition scheme to the email message based upon the associated at least one expiry indicator; and
processing the email message according to the assigned disposition scheme.

2. The method of claim 1, wherein the expiry indicator comprises tagged expiry data associated with the email message.

3. The method of claim 1, further comprising parsing of email message content, identification of at least one relevant expiry factor, and assignment of at least one expiry indicator to the email message based upon the at least one identified relevant expiry factor.

4. The method of claim 3, wherein the parsing comprises accessing at least one URL included in the email message content and parsing the linked data for at least one selected from (a) a relevant expiry factor, and (b) a source identifier.

5. The method of claim 4, further comprising associating at least one of the relevant expiry factor and the linked source identifier with the email message containing the parsed URL.

6. The method of claim 3, further comprising, in an absence of tagged expiry data and when multiple expiry factors are identified in parsed email message content, attributing a certainty score to each identified expiry factor, and using the expiry factor having the highest certainty score as the expiry indicator for the parsed email communication.

7. The method of claim 6, further comprising comparing the highest certainty score to a predetermined threshold and if the threshold is not met, flagging the message for additional evaluation.

8. The method of claim 1, wherein the expiry scheme is one selected from deletion, archiving, flagging, calendaring, source assignment, and replacement.

9. The method of claim 7, wherein the source assignment expiry scheme is selected, and further comprising applying a different expiry scheme to at least one prior email message assigned to the same source.

10. The method of claim 1, wherein the method is performed in response to receipt of an email message.

11. The method of claim 1, wherein the method is performed on stored email messages and initiated by at least one selected from (a) a time interval and (b) a quota.

12. A method for email message management, comprising:
at at least one computer system having at least one processor, performing the operations of:
associating at least one Identifier, selected from a Sender ID (SID) or a Message ID (MID) with a particular email message;
identifying the email message by its associated Identifier; and
applying a selected expiry scheme to the email message based on the associated Identifier.

13. The method of claim 12, wherein the email message has been received by a recipient and the identifying of the email message and applying of a selected expiry scheme is initiated by a sender of the email message.

14. The method of claim 12, wherein the associating of the at least one Identifier occurs on a first computer system associated with a sender of the email message, and the identifying of the email message and applying of a selected expiry scheme occurs on a second computer system associated with a recipient of the email message.

15. A non-transitory computer readable storage medium, storing at least one program for execution by at least one processor, the at least one program comprising instructions for:
accessing an email message to determine expiry indicators;
associating the expiry indicator with the email message;
assigning a message disposition scheme to the email message; and
processing the email message according to the assigned message disposition scheme.

16. The non-transitory computer readable storage medium of claim 15, wherein the email message is disposed on a remote computer system.

17. The non-transitory computer readable storage medium of claim 15, wherein the at least one program further comprises instructions for assigning at least one selected from an SID and MID to the email message.

18. The non-transitory computer readable storage medium of claim 17, wherein assigning of the at least one selected from the SID and the MID occurs at on a sender-associated computer system, and wherein processing the email message according to the assigned message disposition scheme occurs on a recipient-associated computer system.

19. The non-transitory computer readable storage medium of claim 18, wherein the at least one program further comprises instructions for remotely communicating with the sender-associated computer system to initiate the processing of the email message.

20. The non-transitory computer readable storage medium of claim 19, wherein the at least one program further comprises instructions for limiting the processing of the email messages to only those messages assigned a selected SID.
